(19) United States
(12) Patent Application Publication
(10) Pub. No.: US 2009/0199879 A1
(43) Pub. Date: Aug. 13, 2009

(54) Portable and modular washing unit for truboprops of aircraft

(76) Inventor: Angelo Reboa, La Spezia (IT)

Correspondence Address: POLLACK, P.C., THE CHRYSLER BUILDING, 132 EAST 43RD STREET, SUITE 760, NEW YORK, NY, 10017, US

(21) Appl. No.: 11/920,931

(22) PCT Filed: May 9, 2006
(86) PCT No.: PCT/IT2006/000330

§ 371 Date: Apr. 6, 2009

(30) Foreign Application Priority Data
May 19, 2005 (IT) SP 2005 U000004

(51) Int. Cl. B08B 3/04

(52) U.S. Cl. 134/123

(57) ABSTRACT

A washing unit for turboprops of aircraft comprising a hydropneumatic accumulator suitable for supplying washing liquid contained therein at a controlled pressure, and a filling member, motorized and manual, for feeding the washing liquid into the accumulator, which can be connected alternatively to the motorized filling member or to the manual filling member. A manually actuated device is also provided for pressurization of the accumulator, so that the washing unit can be used both in areas equipped for this operation and in non-equipped areas.

### FIELD OF THE INVENTION

The present invention relates to a portable and modular washing unit for turboprops of aircraft, more particularly P&W PT6T Series T3-T6 turboprops, installed on the helicopter AB 412, and Lycoming LTP 101-700, installed on the Piaggio P166 DL 3SEM aircraft, or equivalent.

### BACKGROUND ART

The problem related to the gradual accumulation of saline residues and contaminants dispersed in the air on the surfaces of the blading and of the rotor of the turboprops of aircraft is known. This phenomenon progressively impairs the functional parameters of the turboprop that must therefore be restored in order to avoid jeopardising the efficiency of the machine. The traditional devices for cleaning compressors are heavy and bulky and totally unsuitable for transport on an aircraft such as a helicopter, or for use in field during working missions.

### SUMMARY OF THE INVENTION

The object of the present invention is to provide a washing unit for turboprops of aircraft that is easy to transport and to use both for desalinating washes and for performance restoring washes and which allows the maximum practicality, maneuverability and transportability during operations of washing and performance restoring of the aircraft turbines, both in conditions of operation on the runway and in areas lacking in any energy source.

This object is achieved with the portable and modular washing unit for turboprops of aircraft according to the present invention whose basic features are claimed in claim 1.

The features of modularity, compactness, lightness, simplicity and possible air transport make the washing unit according to the present invention the ideal instrument for routine maintenance, which can be performed on the aircraft, both in areas devoted to the aircraft maintenance or outside in emergency areas.

### BRIEF DESCRIPTION OF THE DRAWINGS

The features and the advantages of the portable and modular washing unit for turboprops of aircraft according to the present invention will be made clearer by the following description of one of its embodiments, given by way of a non-limiting example with reference to the accompanying drawings, in which:

FIGS. 1, 2 and 3 show the washing unit according to the invention in a front, side and rear view respectively;

FIGS. 4 and 5 are front and rear perspective views of the washing unit of FIG. 1;

FIG. 6 is a plan view of the control panel of the washing unit according to the invention;

FIG. 7 is a plan view from the inside of the control panel of FIG. 6, specularly reversed in relation to the latter;

FIG. 8 schematically shows the hydraulic circuit of the washing unit according to the invention;

FIG. 9 shows in a front view two washing units according to the invention, connected modularly one to the other;

FIG. 10 shows a set of accessories associated with the washing unit according to the invention that can be adopted for use in non-equipped areas.

### DETAILED DESCRIPTION OF THE INVENTION

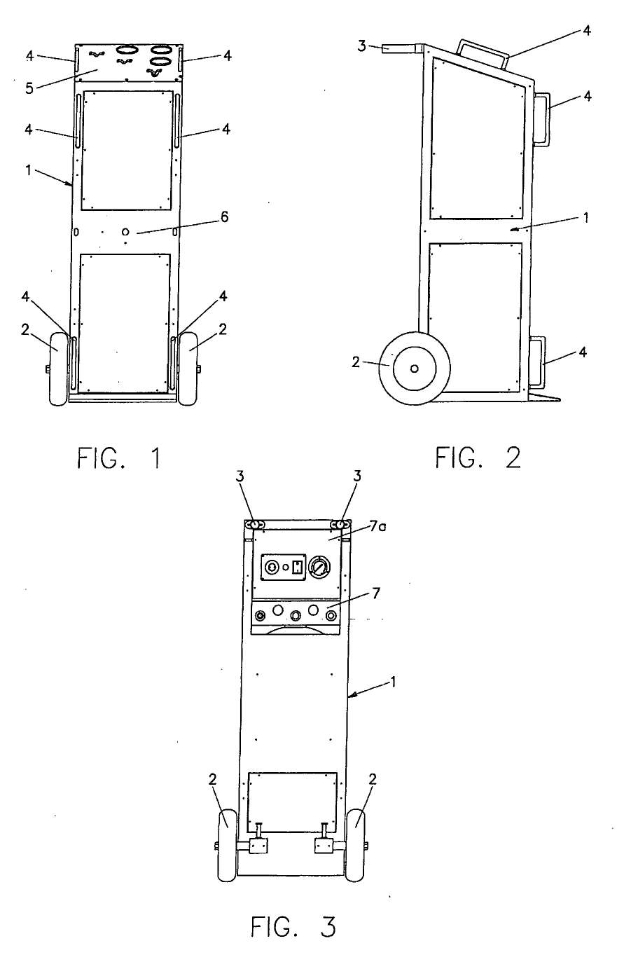

Referring to FIGS. 1-5, the washing unit according to the invention comprises a frame 1 with open welded and box-shaped profile, mounted on wheels 2 to ensure easy towability thereof and fitted, on the upper side, with a pair of tiltable hand-grips 3 for its towing or pushing and three pairs of handles 4 for its raising. A pair of the handles 4 extends from a control panel 5 located at the top of the box-shaped frame 1, while the other two pairs of handles 4 extend at the sides of a front panel 6, on which the connection is provided for manual filling means, as will be described herein below. On a rear panel 7 there are hydraulic connections for service fluids and, again at the rear, a further panel 7a is provided on which the electrical connections to the aircraft and a pressure gauge 35 indicating the pre-charge value of the accumulator are present.

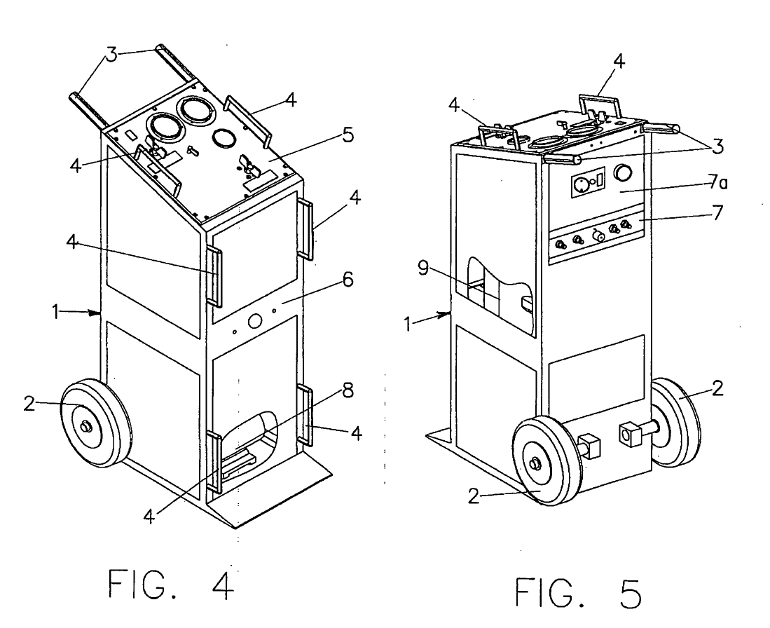

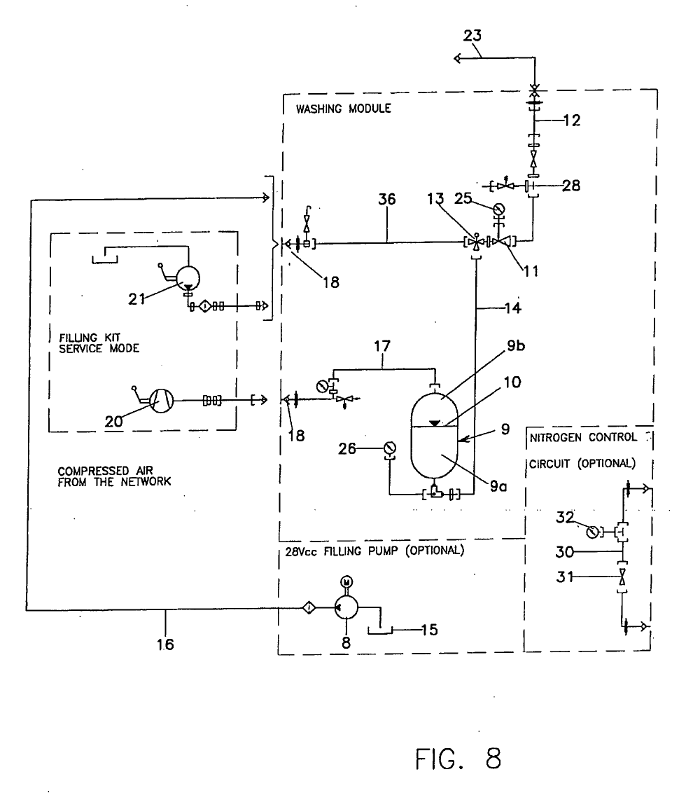

As shown in particular in FIGS. 4 and 5, an electrical pump 8 is placed on the base of the box-shaped frame 1 and a hydropneumatic accumulator 9 is placed above the pump 8. The accumulator is a stainless steel tank divided into two chambers by a separation membrane 10, as shown in the hydraulic diagram of FIG. 8. The two chambers of the accumulator 9, denoted by 9a and 9b in FIG. 8, are intended to contain respectively a washing fluid and a pressurisation fluid, in particular compressed air. The feeding of washing fluid into the chamber 9a of the accumulator 9 causes an increase in pressure of the pressurisation fluid present in the chamber 9b up to a predefined value. The pressure that is generated in this way in the accumulator 9 provides the necessary energy for the washing fluid supply. The value of the final filling pressure is considerably higher than the pressure of use, so that at the output of the chamber 9a a pressure regulator 11 is provided (FIGS. 7 and 8), installed on the delivery line 12 of the accumulator 9, which reduces the pressure of the washing mixture to the value-laid down by the washing specifications established by the manufacturer of the turboprop, allowing a controlled outflow of the mixture. The delivery conduit 12 is connected to the accumulator 9 via a three-way valve 13 and a pipe 14.

The electrical filling pump 8 sucks the washing fluid from a tank 15 and is connected to the three-way valve 13 via filling conduits 16 and 36. The chamber 9b can instead be connected via a hose 17 to pressurisation means, for example a battery compressed air gun or a pedal pump.

The washing module also has two connectors 18, respectively on the filling conduit 36 and on the hose 17, for the hydraulic connection to portable filling means for the washing and pressurisation fluid that can be used when washing operations have to be performed on field during a working mission in areas where suitable equipment or electrical energy are not available. More particularly, these portable means comprise a manual pump 21 and a pneumatic pedal pump 20 for feeding the pressurisation fluid into the chamber 9b of the accumulator. Alternatively the manual pump 21 can be replaced by the electrical pump 8, which can be connected to the service intake of the aircraft, like the one shown in FIG. 4. Other useful accessories, which may be contained conveniently in a special bag 22, can be a flexible tube 23, used for the delivery of the washing fluid, and a set of accessories for attachment and depressurisation 24.

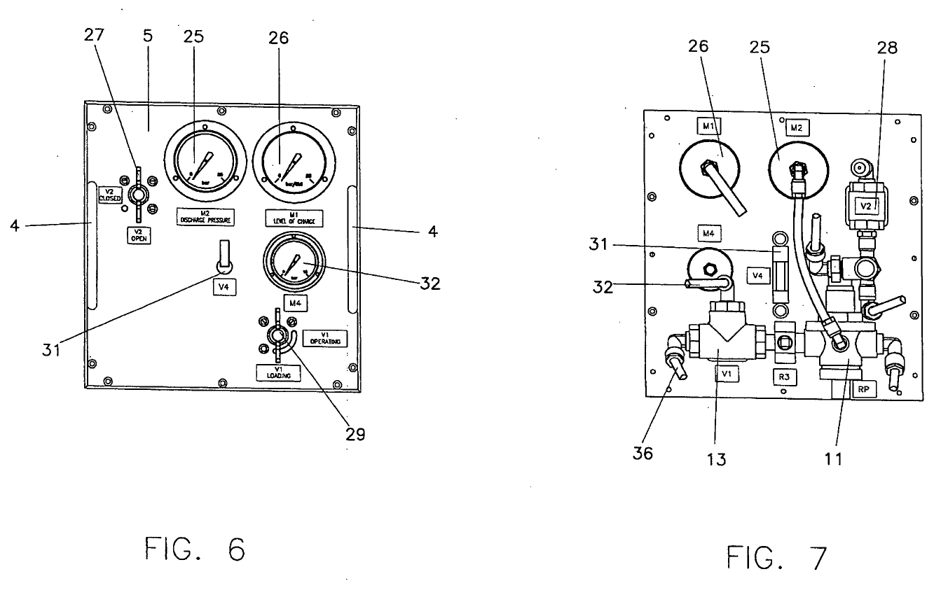

As shown in FIGS. 6 and 7, positioned on the control panel 5 are a pressure gauge 25 for the control of the delivery pressure, a pressure gauge 26 for the control of the level of fluid available inside the accumulator, a key 27 for the opening and closure of a delivery valve 28 located on the delivery conduit 12 and a key 29 for setting the three-way valve 13 from the working position to the filling position and vice versa. The valves are positioned immediately below the control panel 5 as shown in FIG. 7, where the valve 11 for regulating the supply pressure of the washing liquid is also shown.

The washing unit according to the invention also provides for the possibility of blowing nitrogen during washes performed on particular turboprops (for example the Lycoming turboprop installed on the Piaggio P166 DL3 aircraft). For this purpose a bypass 30 is provided, with relative fast couplings mounted on the panel 7 for the connection to a feed hose (not shown) coming from the gas cylinder and a supply hose (not shown), as well as a feed valve 31 and a control pressure gauge 32 placed respectively below and above the control panel 5.

The washing unit according to the present invention allows the performance both of a desalinated washing of a turboprop, performed with distilled water, and the washing for the recovery of performances which, as is known, is carried out in two steps. During the first step a mixture of distilled water and detergent is used, while in the second step a double rinsing with distilled water is carried out.

Thanks to the accessories supplied, the washing unit according to the invention can be transported on the aircraft in a totally emptied and depressurised condition, for example in the tail boom of a helicopter, appropriately attached via the various anchorage points formed on the frame 1, during a mission to use it in non-equipped areas.

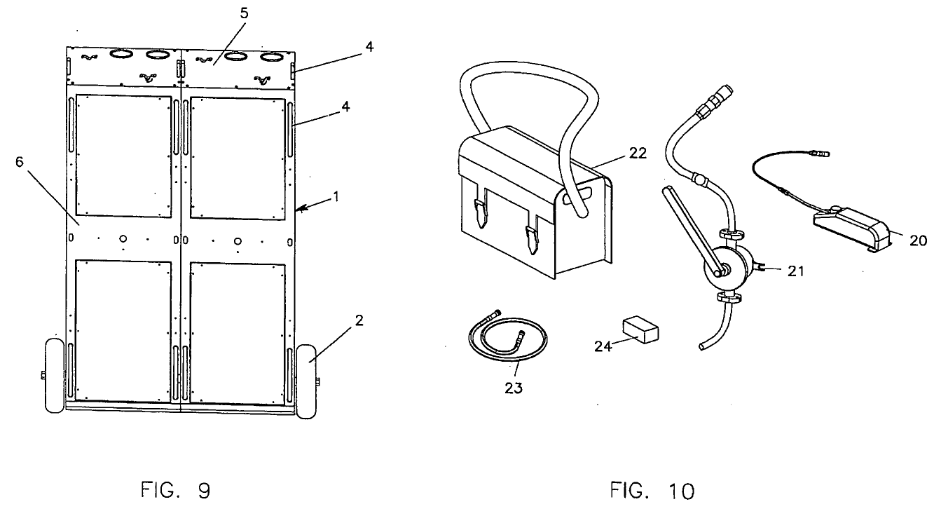

Moreover, given its total modularity, two washing unit modules according to the invention can be joined together, side by side, as shown in FIG. 9, for use in a hangar, in the case of washing to restore performances wherein a mixture of detergent and distilled water for the subsequent rinsing has to be used.

Variations and/or changes may be made to the washing unit for turboprops of aircraft according to the present invention, without thereby departing from the scope of the invention as set forth in the following claims.

What is claimed is:

1. A washing unit for turboprops of aircraft, the unit comprising a hydropneumatic accumulator suitable for supplying washing liquid contained therein at a controlled pressure, a motorized filling member and a manual filling member, for feeding the washing liquid into the accumulator, which can be connected alternatively to the motorized filling member or to the manual filling member, a manually actuated device also provided for pressurization of the accumulator, such that the washing unit can be used both in areas equipped for this operation and in non-equipped areas.

2. The washing unit set forth in claim 1, wherein the hydropneumatic accumulator is a tank divided into a first and second chamber by an elastic membrane, the washing liquid being contained in the first chamber, the first chamber being fit to be connected hydraulically to the motorized filling member or, alternatively, to the manual filling member, the second chamber being fit to be connected pneumatically to the automatic pressurization member or to the manual pressurization member.

3. The washing unit set forth in claim 1, further comprising a transportable box-shaped frame wherein the hydropneumatic accumulator and the motorized member for filling the washing liquid are placed.

4. The washing unit set forth in claim 1, wherein the manual filling member comprises a manual pump.

5. The washing unit set forth in claim 1, wherein the manually actuated pressurization device comprises a pneumatic pedal pump.

6. The washing unit set forth in claim 1, further comprising a kit of accessories for carrying out washing in non-equipped areas, which includes a manual pump, a pneumatic pedal pump and an accessory for depressurization.
